(19) United States
(12) Patent Application Publication
(10) Pub. No.: US 2009/0227322 A1
(43) Pub. Date: Sep. 10, 2009

(54) Slot Machine

(75) Inventor: Hiroki SAITO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/114,171

(22) Filed: May 2, 2008

Related U.S. Application Data
(60) Provisional application No. 61/033,562, filed on Mar. 4, 2008.

(51) Int. Cl. A63F 13/00

(52) U.S. Cl. 463/20

(57) ABSTRACT

A slot machine includes: a display device having a plurality of symbol display regions in which plural types of symbols are displayed; a memory for storing identification data of the symbols determined to be rearranged in the individual symbol display regions of a symbol matrix; and a processor for controlling the display device and the memory, the processor being programmed to: (a) execute a basic game; (b) execute a free game in a case where a predetermined condition is met during the basic game; (c) store once each free game in the memory, the identification data of the symbols determined to be rearranged in the individual symbol display regions of the symbol matrix during the free game; and (d) rearrange the plural types of symbols in the individual symbol display regions while maintaining a rearrangement status of the symbols corresponding to second identification data without rearranging the symbols corresponding to first identification data determined to be rearranged, in a case where a predetermined relationship is established between the first identification data of the symbols determined to be rearranged during a next free game and the second identification data of the symbols, having been stored in the memory, the symbols being rearranged in the individual symbol display regions during a previous free game.

### CROSS-REFERENCE TO RELATED APPLICATIONS

This application claims priority of U.S. Provisional Application No. 61/033,562 filed on Mar. 4, 2008. The contents of this application are incorporated herein by reference in their entirety.

### BACKGROUND OF THE INVENTION

1. Field of the Invention

The present invention relates to a slot machine.

2. Description of the Related Art

Conventionally, slot machines known as a type of gaming machines are constituted so as to: start games by players inserting coins or the like into the gaming machine; variably display columns of symbols in predetermined regions of the gaming machine while they are displayed in a stopped state after a predetermined period has elapsed; and award payout based on a combination of symbols in a stopped state.

In addition, the above slot machines are generally constituted to judge whether or not a winning combination allowed to award payout is established, based on whether or not a predetermined number of symbols of the same type (for example, “CHERRY” or “7”) are arranged along a preset payline. In the conventional slot machine, in a case where a predetermined number or more of symbols of the same type are arranged, it has been a common routine to award payout based on the number of the aforementioned arranged symbols, regardless of the payout line.

Further, many of the conventional slot machines have been known which conduct two types of games, i.e., a basic game and a free game. The basic game is executed upon consumption of gaming values (such as coins or credits) corresponding to the bet amount. On the other hand, the free game is executed without consuming gaming values corresponding to the bet amount

The basic game is switched to the free game when a predetermined condition is met. The condition includes a case in which, for example, a specific symbol is displayed in a stopped state during the basic game. The free game is switched to the basic game when a predetermined condition is met. The condition includes a case in which, for example, the free games are executed a predetermined number of times.

In the conventional slot machines, it has been a common routine to raise players' feeling of expectation for the free game by changing arrangement of symbols during the free game differently from that during the basic game. For example, U.S. Pat. No. 6,394,902-B1 describes a slot machine in which a total of fifteen symbols are displayed in three rows and five columns with the use of video reels. This slot machine changes symbol columns arranged on reels during the free game differently from that during the basic game, in which eight types of symbols are decreased to five. In this manner, a probability of awarding payout can be apparently increased during the free game.

In the aforementioned conventional slot machines, however, irrespective of whichever of the basic game and the free game is in progress, the symbols of different types have been randomly arranged in combination and sequential order. These slot machines determine the contents of the prize to be awarded, based on a combination of multiple symbols that have been arranged in a display device. Therefore, players are allowed to have the feeling of expectation only for random payout based on a combination of plural types of symbols that have been randomly arranged in the display device. Accordingly, a need exists for the advent of a slot machine which can offer new entertainability.

The present invention has been made in view of the above-described circumstance. It is an object of the present invention to provide a novel slot machine and a controlling method thereof by enhancing entertainability associated with rearrangement of the symbols during the free game.

### SUMMARY OF THE INVENTION

A first aspect of the present invention is a slot machine including: a display device having a plurality of symbol display regions in which plural types of symbols are displayed; a memory for storing identification data of the symbols determined to be rearranged in the individual symbol display regions of a symbol matrix; and a processor for controlling the display device and the memory, the processor being programmed to: (a) execute a basic game; (b) execute a free game in a case where a predetermined condition is met during the basic game; (c) store once each free game in the memory, the identification data of the symbols determined to be rearranged in the individual symbol display regions of the symbol matrix during the free game; and (d) rearrange the plural types of symbols in the individual symbol display regions while maintaining a rearrangement status of the symbols corresponding to second identification data without rearranging the symbols corresponding to first identification data determined to be rearranged, in a case where a predetermined relationship is established between the first identification data of the symbols determined to be rearranged during a next free game and the second identification data of the symbols, having been stored in the memory, the symbols being rearranged in the individual symbol display regions during a previous free game.

According to the first aspect of the present invention, in a case where a predetermined relationship is established between the symbols having been rearranged in the symbol matrix elements during the previous free game and the symbols determined to be rearranged during the next free game, the symbols having been rearranged during the previous free game are to be rearranged in the symbol matrix element. For example, in a case where the symbols “7” have been rearranged in the symbol matrix elements during the previous free game, and the symbols “1Bar” are determined to be rearranged during the next free game, the symbols “7” having been rearranged during the previous free game are to be rearranged in the symbol matrix elements. Therefore, the slot machine is allowed to realize the free game which raises the player's expectation, thereby enhancing entertainability related to rearrangement of the symbols during the free game.

A second aspect of the present invention is a slot machine constituted as set fourth below. In the first aspect, the processor is characterized by rearranging the plural types of symbols in the individual symbol display regions while maintaining the rearrangement status of the symbols corresponding to the second identification data without rearranging the symbols corresponding to the first identification data determined to be rearranged, in a case where the symbols corresponding to the second identification data are allowed to award a higher payout than that of the symbols corresponding to the first identification data in the itemized (d).

According to the second aspect of the present invention, in a case where the symbols having been rearranged during the previous free game are allowed to award a higher payout than that of the symbols determined to be rearranged during the next free game, the symbols having been rearranged during the previous free game are to be rearranged in the symbol matrix element. For example, where the symbol “3Bar” has been rearranged during the previous free game, and the symbols “1Bar” are determined to be rearranged during the next free game, the symbols “3Bar” having been rearranged during the previous free game are to be rearranged in the symbol matrix element. Therefore, the slot machine is allowed to realize the free game which raises the player's expectation, thereby enhancing entertainability related to rearrangement of the symbols during the free game.

A third aspect of the present invention is a slot machine constituted as set forth below. In the first or second aspect, the processor is further programmed to: (e) upon execution of the itemized (d), display in a superimposed manner the symbols corresponding to the first identification data, the symbols being determined to be rearranged but actually not rearranged, on the symbols corresponding to the second identification data rearranged in the individual symbol display regions.

According to the third aspect of the present invention, in a case where the symbols having been rearranged during the previous free game are determined to be rearranged in the symbol matrix element, the symbols allowed to award a higher payout, the symbols having been rearranged during the previous free game, are to be displayed after superimposed on the symbol rearranged during the next free game. Therefore, the slot machine is allowed to realize the free game which raises the player's expectation, thereby enhancing entertainability related to rearrangement of the symbols during the free game

A fourth aspect of the present invention is a slot machine including: a display device having a plurality of symbol display regions in which plural types of symbols are displayed; a memory for storing identification data of the symbols determined to be rearranged in the individual symbol display regions of a symbol matrix; and a processor for controlling the display device and the memory, the processor being programmed to: (a) execute a basic game; (b) execute a free game in a case where a predetermined condition is met during the basic game; (c) store once each free game in the memory, the identification data of the symbols determined to be rearranged in the individual symbol display regions of the symbol matrix during the free game; and (d) rearrange the plural types of symbols in the individual symbol display regions while maintaining a rearrangement status of the symbols corresponding to second identification data without rearranging the symbols corresponding to first identification data determined to be rearranged, in a case where the symbols corresponding to the second identification data having been stored in the memory and rearranged in the individual symbol display regions during a previous free game is allowed to award a higher payout than that of the symbols corresponding to the first identification data, determined to be rearranged during a next free game.

According to the fourth aspect of the present invention, in a case where the symbols having been rearranged in the symbol matrix elements during the previous free game are allowed to award a higher payout than that of the symbols determined to be rearranged during the next free game, the symbols having been rearranged during the previous free game are to be rearranged in the symbol matrix elements. For example, the symbols “3Bar” have been rearranged in the symbol matrix elements during the previous free game, and the symbols “1Bar” are determined to be rearranged during the next free game, the symbols “3Bar” allowed to award a higher payout, the symbol having been rearranged during the previous free game, are to be rearranged in the symbol matrix element. Therefore, the slot machine is allowed to realize the free game which raises expectation of a player, thereby enhancing entertainability related to rearrangement of the symbols during the free game.

A fifth aspect of the present invention is a slot machine constituted as set forth below. In the fourth aspect, the processor is further programmed to: (e) upon execution of the itemized (d), display in a superimposed manner the symbols corresponding to the first identification data, determined to be rearranged but actually not rearranged, on the symbols corresponding to the second identification data rearranged in the individual symbol display regions.

According to the fifth aspect of the present invention, in a case where the symbols having been rearranged during the previous free game are determined to be rearranged in the symbol matrix elements, the symbols allowed to award a higher payout, the symbols having been rearranged during the previous free game, are displayed after superimposed on the symbol rearranged during the next free game. Therefore, the slot machine is allowed to realize the free game which raises the player's expectation, thereby enhancing entertainability related to rearrangement of the symbols during the free game.

A sixth aspect of the present invention is a slot machine including: a display device having a plurality of symbol display regions in which plural types of symbols are displayed; a memory for storing identification data of the symbols determined to be rearranged in the individual symbol display regions of a symbol matrix; and a processor for controlling the display device and the memory, the processor being programmed to: (a) execute a basic game; (b) execute a free game in a case where a predetermined condition is met during the basic game; (c) store once each free game in the memory, the identification data of the symbols determined to be rearranged in the individual symbol display regions of the symbol matrix during the free game; (d) rearrange the plural types of symbols in the individual symbol display regions while maintaining a rearrangement status of the symbols corresponding to second identification data without rearranging the symbols corresponding to first identification data determined to be rearranged, in a case where the symbols corresponding to the second identification data having been stored in the memory and rearranged in the individual symbol display regions during a previous free game are allowed to award a higher payout than that of the symbols corresponding to the first identification data, determined to be rearranged during a next free game; and (e) upon execution of the itemized (d), display in a superimposed manner the symbols corresponding to the first identification data, determined to be rearranged but actually not rearranged, on the symbols corresponding to the second identification data, the symbols being rearranged in the individual symbol display regions.

According to the sixth aspect of the present invention, in a case where the symbols having been rearranged in the symbol matrix elements during the previous free game is allowed to award a higher payout than that of the symbols determined to be rearranged during the next free game, the symbols having been rearranged during the previous free game, are to be rearranged in the symbol matrix element. For example, where the symbols “WILD” have been rearranged in the symbol matrix elements during the previous free game, and the symbols “1Bar” are determined to be rearranged during the next free game, the symbols “WILD” allowed to award a higher payout, the symbols having been rearranged during the previous free game, are to be rearranged in the symbol matrix element. Therefore, the slot machine is allowed to realize the free game which raises the player's expectation. Further, the symbols “WILD” are displayed after superimposed on the symbols “1Bar”, thereby enhancing entertainability related to rearrangement of the symbols during the free game.

### BRIEF DESCRIPTION OF THE DRAWINGS

FIG. 1A is a view showing an exemplary symbol matrix during a free game according to a first embodiment;

FIG. 1B is a view showing an exemplary symbol matrix during a free game according to the first embodiment;

FIG. 1C is a view showing an exemplary symbol matrix during a free game according to the first embodiment;

FIG. 2 is a perspective view schematically showing a frame format of a slot machine according to the first embodiment;

FIG. 3 is a block diagram depicting an internal construction of the slot machine shown in FIG. 2.

FIG. 4A is a table providing a correspondence relationship between various symbols and payouts according to the first embodiment;

FIG. 4B is a table providing a correspondence relationship between various symbols and payouts according to the first embodiment;

FIG. 5 is a table providing patterns of symbols rearranged during the free game according to the first embodiment;

FIG. 6A is a view showing an exemplary image displayed during the free game in the slot machine shown in FIG. 2;

FIG. 6B is a view showing an exemplary image displayed during the free game in the slot machine shown in FIG. 2;

FIG. 7A is a view showing an exemplary image displayed during the free game in the slot machine shown in FIG. 2;

FIG. 7B is a view showing an exemplary image displayed during the free game in the slot machine shown in FIG. 2;

FIG. 8A is a view showing an exemplary image displayed during the free game in the slot machine shown in FIG. 2;

FIG. 8B is a view showing an exemplary image displayed during the free game in the slot machine shown in FIG. 2;

FIG. 9A is a view showing an exemplary image displayed during the free game in the slot machine shown in FIG. 2;

FIG. 9B is a view showing an exemplary image displayed during the free game in the slot machine shown in FIG. 2;

FIG. 10 is a flowchart showing a subroutine of a main process according to the first embodiment;

FIG. 11 is a flowchart showing a subroutine of a game execution process according to the first embodiment;

FIG. 12 is a flowchart showing a subroutine of a free game execution process according to the first embodiment;

FIG. 13 is a flowchart showing a subroutine of a free game rearrangement process according to the first embodiment;

FIG. 14 is a flowchart showing a subroutine of a frame display process according to the first embodiment;

FIG. 15 is a view showing an exemplary symbol matrix during a free game according to a second embodiment;

FIG. 16A is a view showing an exemplary symbol matrix during a free game according to the second embodiment;

FIG. 16B is a view showing an exemplary symbol matrix during a free game according to the second embodiment;

FIG. 16C is a view showing an exemplary symbol matrix during a free game according to the second embodiment; and

FIG. 17 is a view showing an exemplary symbol matrix during a free game according to the second embodiment.

### DESCRIPTION OF THE PREFERRED EMBODIMENTS

First, a slot machine 10 according to a first embodiment will be described with referring to the drawings. The slot machine according to the first embodiment is a so-called video slot machine, which has an image display panel such as a liquid crystal display and executes a game by displaying images of various symbols on the image display panel.

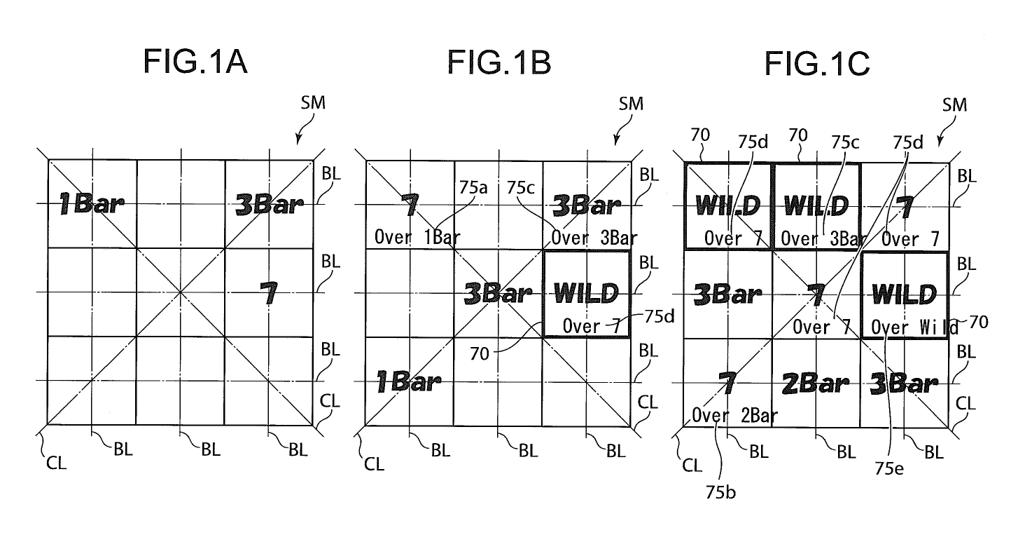

FIGS. 1A and 1B are views each showing an exemplary symbol matrix during a free game according to the first embodiment. FIG. 1C is a view showing an exemplary symbol matrix at the time of termination of the free game according to the first embodiment. Of the free games executed a plurality of times, FIG. 1A shows the exemplary symbol matrix during a first time's free game; FIG. 1B shows the exemplary symbol matrix during a second time's free game; and FIG. 1C shows the exemplary symbol matrix during a last time's free game. The slot machine 10 according to the present invention executes either of two modes of games, i.e., a basic game and a free game. The basic game is executed upon consuming a gaming value corresponding to the amount bet by a player. The free game is executed without consuming such a gaming value. The slot machine 10 is of a stand-alone type, which is not connected to a network, whereas the present invention is applicable to a networked slot machine.

As shown in FIGS. 1A to 1C, symbol matrix elements SM are displayed in a lower image display panel 16 included in the slot machine 10 according to the present invention. The symbol matrix elements SM are made up of a total of nine symbols in three columns and three rows. In the symbol matrix elements SM, six basic lines BL are set along the columns or the rows, respectively. In the embodiments of the present invention, the basic line is defined as a winning line other than a cross line. Furthermore, two cross lines CL obliquely across the symbol matrix elements SM are set. The eight wining lines in the embodiments of the present invention contain the basic lines BL and the cross lines CL.

In the embodiments of the present invention, any of the symbols, “Blank”, “1Bar”, “2Bar”, “3Bar”, “7”, and “WILD” are rearranged in the symbol matrix elements SM. Payout is determined based on a combination of these symbols on the wining lines and the number of symbols rearranged in the symbol matrix elements SM.

As shown in FIG. 1A, any of the symbols “Blank”, “1Bar”, “2Bar”, “3Bar”, “7”, and “WILD” are rearranged in any of the individual symbol matrix elements SM during the free game. The symbols, “Blank”, “1Bar”, “3Bar”, and “7” are rearranged in FIG. 1A.

As shown in FIG. 1B, a level-up display 75 is displayed in a case where any of the symbols “1Bar”, “2Bar”, “3Bar”, “7”, and “WILD” have been rearranged in any of the individual symbol matrix elements SM during the previous free game. The symbols “1Bar”, “3Bar”, and “7” have been rearranged as shown in FIG. 1A, so that the symbols rearranged in FIG. 1B are “1Bar”, “3Bar”, “7”, and “WILD” allowed to award higher payouts than those of the symbols rearranged in FIG. 1A. In the symbol matrix element SM in which the symbol “1Bar” has been rearranged as shown in FIG. 1A, a level-up display 75a “Over 1Bar” is displayed in a superimposed manner and the symbol “7” is rearranged in FIG. 1B, which is allowed to award a higher payout than that of the previously-rearranged symbol “1Bar”.

In the symbol matrix element SM in which the symbol “3Bar” has been rearranged as shown in FIG. 1A. a level-up display 75b “Over 3Bar” is displayed in a superimposed manner and the symbol “3Bar” allowed to award a higher payout than that of the previously-rearranged symbol “3Bar” is rearranged in FIG. 1B. Further, in the symbol matrix element SM in which the symbol “7” has been rearranged as shown in FIG. 1A, a level-up display 75d “Over 7” is displayed in a superimposed manner; the symbol “WILD” allowed to award a higher payout than that of the previously-rearranged symbol “7” is rearranged; and a frame 70 is displayed to make identifiable thee rearrangement of the symbol “WILD” in FIG. 1B.

As shown in FIG. 1C, in a case where any of the symbols, “1Bar”, “2Bar”, “3Bar”, “7”, and “WILD” are rearranged in any of the individual symbol matrix elements SM during the previous free games by the time of the last free game, the level-up display 75 is displayed in a superimposed manner. In FIG. 1C, in the symbol matrix element SM in which the symbol “2Bar” has been rearranged during the previous free game, the level-up display 75b “Over 2Bar” is displayed in a superimposed manner and the symbol “7” allowed to award a higher payout than that of the previously-rearranged symbol “2Bar” is displayed. In the symbol matrix element SM in which the symbol “3Bar” has been rearranged during the previous free game, a level-up display 75c “Over 3Bar” is displayed in a superimposed manner and the symbol “WILD” allowed to award a higher payout than that of the previously-rearranged symbol “3Bar” is displayed. In the symbol matrix element SM in which the symbol “7” has been rearranged during the previous free game, the level-up display 75d “Over 7” is displayed in a superimposed manner and the symbol “7” or “WILD” allowed to award a higher payout than that of the previously-rearranged symbol “7” is rearranged.

In a case where the symbol “WILD” has been rearranged, the frame 70 is displayed so as to identify the rearrangement of the symbol “WILD”. A payout is then determined based on a combination of the symbols established on a winning line and the number of symbols rearranged in the symbol matrix elements SM.

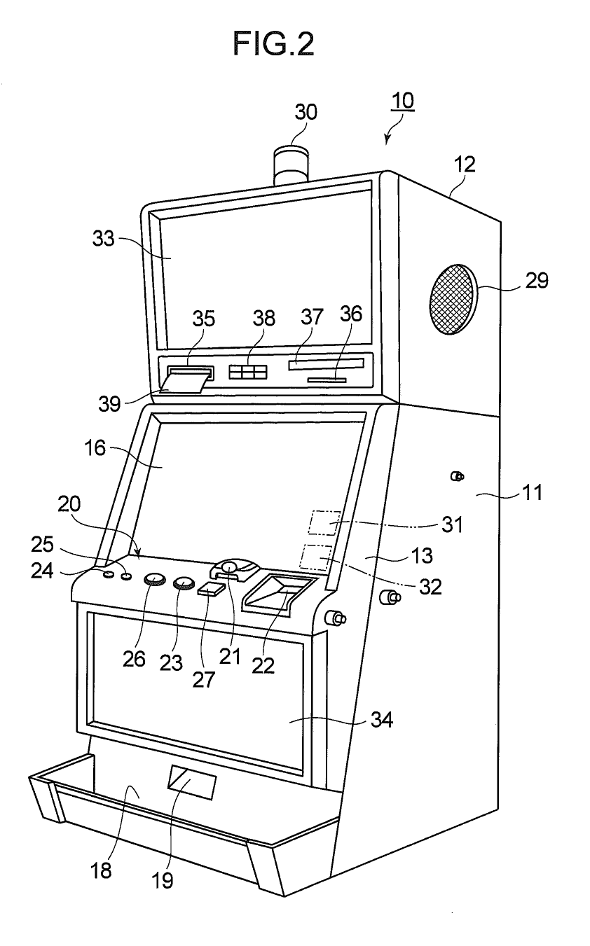

FIG. 2 is a view schematically depicting a frame format of an appearance of the slot machine according to the first embodiment. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

The lower image display panel 16 serving as a display is provided in front of the main door 13. The lower image display panel 16 is provided with a liquid crystal panel, which displays the nine symbol matrix elements SM in three columns and three rows. In each symbol matrix element SM, one symbol is arranged.

In the nine symbol matrix elements SM of the lower image display panel 16, winning lines containing six basic lines BL and two cross lines CL are set. The six basic lines BL are along the columns or rows, respectively while the cross lines are obliquely across the symbol matrix elements SM. The basic lines BL and the cross lines CL as winning lines define a combination of symbols (see FIGS. 1A to 1C).

A credit amount display section 31 of the lower image display panel 16 displays the number of credited coins by way of an image. A payout amount display unit 32 displays by way of an image the number of coins to be paid if a predetermined combination of symbols is established on the winning line, or alternatively, a predetermined number of symbols are rearranged.

Provided on a lower side of the lower image display panel 16 are a control panel 20 having a plurality of buttons 23 to 27 through which command regarding the process of the game will be input by a player, a coin receiving slot 21 for receiving coins into the cabinet 11, and a bill validator 22.

On the control panel 20, a start button 23, a change button 24, a cashout button 25, a 1-BET button 26, and a max-BET button 27 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19.

The 1-BET button 26 is intended for entering a command for betting one coin among the credited coins on the game. The max-BET button 27 is intended for entering a command for betting the upper number (50 in this embodiment) of coins that can be bet per game among the credited coins on the game.

The bill validator 22 validates whether or not a bill is legitimate and accepts a legitimate bill into the cabinet 11. The bill validator 22 may be configured so that a barcode-attached ticket 39 described later is readable-thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a lamp 30 and a speaker 29 are provided. On a lower side of the upper image display panel 33, a ticket printer 35, a card reader 36, a data display 37, and a key pad 38 are provided. The ticket printer 35 prints on the ticket, a barcode having encoded thereon data such as the credit amount, the date and time, and the identification number of the slot machine 10, and outputs the printed ticket as the barcode-attached ticket 39. The player can play the game on another slot machine with the barcode attached ticket 39 by causing this slot machine to read the barcode attached ticket 39. Alternatively, the player can exchange the barcode-attached ticket 39 with the bills or the like at a predetermined place (at a cashier inside a casino, for example) of the gaming facility.

The card reader 36 reads data from and write data into a smart card. The smart card is to be owned by the player, which stores data for identifying the player or data regarding the log of games executed by the player, for example. The smart card may store data corresponding to coins, bills, or a credit. As an alternative of a smart card, a magnetic stripe card may be employed. The data display 37 is made up of a fluorescent display and the like, and displays the data read by the card reader or the data input by the player through the key pad 38, for example. The key pad 38 inputs data and commands regarding the ticket issuance or the like.

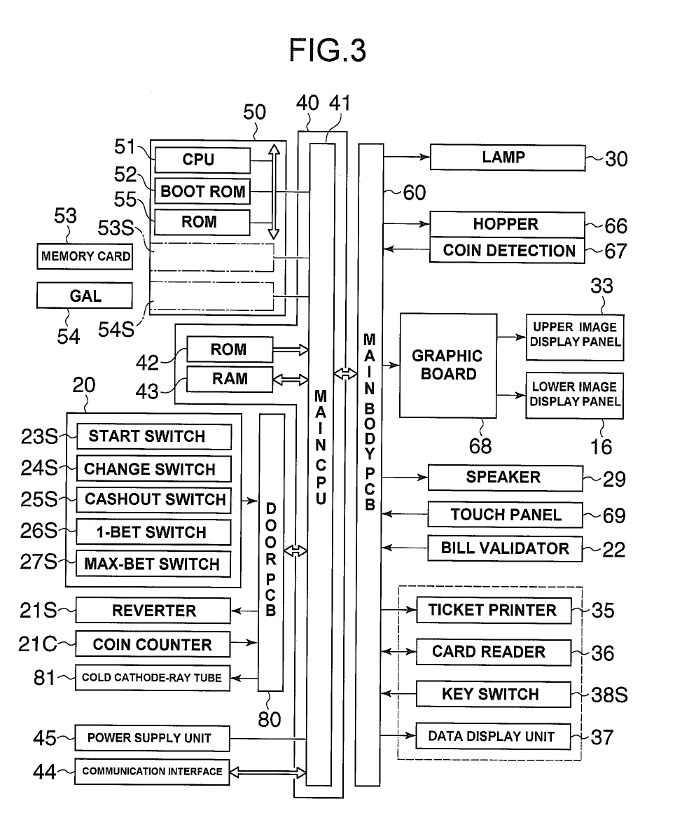

FIG. 3 is a block diagram depicting the internal construction of the slot machine shown in FIG. 2. A gaming board 50 includes: a CPU (Central Processing Unit) 51, a ROM (Read Only Memory) 55 and a boot ROM 52 interconnected by an internal bus; a card slot 53S corresponding to a memory card 53; and an IC socket 54S corresponding to a GAL (Generic Array Logic) 54.

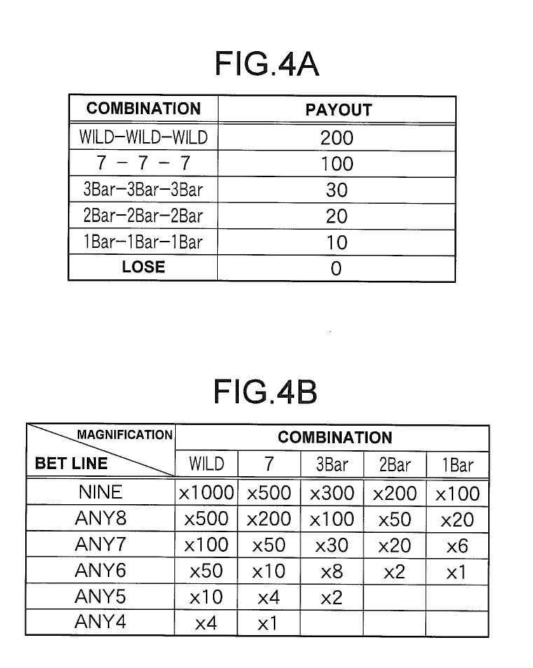

The memory card 53 is formed of a nonvolatile memory such as Compact Flash (registered trademark) and stores game programs. The game programs include a symbol selection program. The aforementioned symbol selection program is intended for determining the symbols to be rearranged in the symbol matrix elements SM. The aforementioned symbol selection program includes symbol weighing data respectively corresponding to plural types of payout ratios (80%, 84%, 88%, for example). The symbol weighting data is indicative of the correspondence relationship between the individual symbols and one or more random numeric values which come under a predetermined numerical range (0 to 255). The payout ratio is determined according to the payout-ratio setting data output from the GAL 54. The symbols to be rearranged in the symbol matrix elements SM are determined depending upon the symbol weighing data corresponding to this payout ratio. Further, the game programs include table data (see FIGS. 4A and 4B) indicating the correspondence relationship between each of the symbols and a payout.

Also, the card slot 53S is configured to allow the memory card 53 to be inserted thereinto or ejected therefrom, and is connected to a mother board 40 through IDE pass. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game program includes data concerning a game progress. Furthermore, the game program includes image data or sound data to be output during the game. The image data include, for example, image data indicative of the symbol matrix.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Further, the IC socket 54S is configured to allow the GAL 54 to be attached thereto and detached therefrom, and is connected to the mother board 40 by a PCI bus. Accordingly, the GAL can be replaced with the replacement GAL 54 to change the payout-ratio setting data.

The CPU 51, the ROM 55, and the boot ROM 52 interconnected by the internal bus are connected to the mother board 40 by the PCI bus. The PCI bus serves to transmit signals between the mother board 40 and the gaming board 50 and supply power from the mother board 40 to the gaming board 50.

The mother board 40 is constructed using a general-purpose mother board commercially available (a printed circuit board on which essential parts of a personal computer are mounted) and includes: a main CPU (Central Processing Unit) 41, a ROM (Read Only Memory) 42; a RAM (Random Access Memory) 43; and a communication interface 44. The main CPU 41 functions as a processor for controlling a display device and memory according to the embodiment of the present invention.

The ROM 42 is made up of a memory device such as a flash memory and stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80, which will be described later, are connected to the mother board 40 by USB. A power supply unit 45 is also connected to the mother board 40.

Connected to the main body PCB 60 and the door PCB 80 are: equipment and devices which generate input signals to be input to the main CPU 41; and equipment and devices of which operations are controlled by a control signal output from the main CPU 41. The main CPU 41 executes a game program stored in the RAM 43 based on an input signal having been input to the main CPU 41 and performs a predetermined computational process, thereby storing results thereof in the RAM 43 or transmitting a control signal to each of equipment and devices as a control process therefor.

A lamp 30, a hopper 66, a coin detecting section 67, a graphic board 68, a speaker 29, a touch panel 69, the bill validator 22, the ticket printer 35, the card reader 36, a key switch 38S, and the data display unit 37 are connected to the main body PCB 60. The lamp 30 is lit up in a predetermined pattern based on a control signal output from the main CPU 41.

The hopper 66 is installed in the cabinet 11 and pays out a predetermined number of coins from the coin payout exit 19 to the coin tray 18 based on a control signal output from the main CPU 41. The coin detecting section 67 is installed inside the coin payout exit 19 and outputs an input signal to the main CPU 41 upon detecting that a predetermined number of coins have been paid out from the coin payout exit 19.

The graphic board 68 controls, based on a control signal output from the main CPU 41, images to be displayed on the upper image display panel 33 and the lower image display panel 16. The credit amount stored in the RAM 43 is displayed on a credit amount display section 31 (see FIG. 2) of the lower image display panel 16. The number of coins to be paid out is displayed at a payout amount display section 31 (see FIG. 2) of the lower image display panel 16. The graphic board 68 is equipped with a VDP (Video Display Processor) which generates image data based on a control signal output from the main CPU 41 and a video RAM which temporarily stores image data generated by the VDP, and the like. The image data used in generating image data with VDP is contained in the game program read from the memory card 53 and stored in the RAM 43.

The bill validator 22 validates whether or not a bill is legitimate and accepts a legitimate bill into the cabinet 11. Upon accepting a legitimate bill, the bill validator 22 outputs an input signal to the main CPU 41 based on the amount of the bill. The main CPU 41 stores in the RAM 43 the credit amount corresponding to the amount of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 transmits to the main CPU 41 the data read from the smart card and writes the read data onto the smart card, based on a control signal from the main CPU 41. The key switch 38S is provided on the key pad 38, and outputs a predetermined input signal to the main CPU 41 when the player operates the key pad 38. The data display 37, based on a control signal output from the main CPU 41, displays the data read by the card reader 36 and the data input by the player through the key pad 38.

A control panel 20, a reverter 21S, a coin counter 21C, and a cold cathode tube 81 are connected to a door PCB 80. The control panel 20 is provided with: a start switch 23S corresponding to the start button 23; a change switch 24S corresponding to the change button 24; a cashout switch 25S corresponding to a cashout button 25; a 1-BET switch 26S corresponding to a 1-BET button 26; and a max-BET switch 27S corresponding to the max-BET button 27. When the player operates the buttons 23 to 27, the corresponding switches 23S to 27S output input-signals to the main CPU 41, respectively.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected.

The reverter 21S operates based on a control signal output from the main CPU 41 and distributes coins recognized as being legitimate by the coin counter 21C into a cash box (not shown in the drawings) or the hopper 66 which is arranged in the slot machine 10. In other words, when the hopper 66 is filled with coins, legitimate coins are distributed by the reverter 21S into the cash box. On the other hand, when the hopper 66 is not filled with coins, legitimate coins are distributed into the hopper 66. The cold cathode tube 81 functions as a backlight installed on rear face side of each of the lower image display panel 16 and the upper image display panel 33, and is lit up based on a control signal output from the main CPU 41.

FIGS. 4A and 4B are views each showing a correspondence relationship between individual symbols and payouts. This table, in which a correspondence relationship between various symbols and payouts is provided, is stored in the ROM 42 and is used to determine a payout. As shown in FIG. 4A, where a predetermined symbol is rearranged on a winning line on which the player has bet, LIN payout is determined based on a winning combination. Furthermore, where the predetermined number of identical symbols are rearranged in the symbol matrix elements SM, as shown in FIG. 4B, ANY payment is determined based on a winning combination. The LIN payout is obtained in a case where a winning combinations, “7-7-7”, “3Bar-3Bar-3Bar”, “2Bar-2Bar-2Bar”, or “1Bar-1Bar-1Bar”, appears on the winning lines set in the nine symbol matrix elements SM, which are made up of the basic lines BL and the cross lines CL. The ANY payout is obtained according to the number of symbols, “WILD”, “7”, “3Bar”, “2Bar”, or “1Bar”, which have been rearranged in the symbol matrix elements SM.

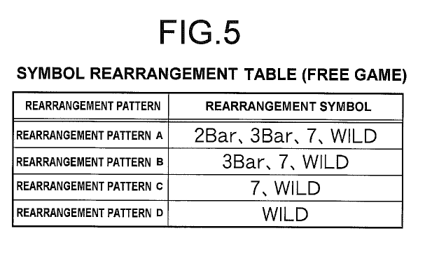

FIG. 5 is a table providing patterns of symbols rearranged in the individual symbol matrix elements SM during the free game according to the first embodiment. This table, in which patterns of symbols are provided, is stored in the ROM 43 and is used to determine symbols to be rearranged during the free game so as to be allowed to award higher payouts than those of symbols having been rearranged in the symbol matrix elements SM during the previous free game. In the table showing patterns of symbols as shown in FIG. 5, a rearrangement pattern is determined based on the symbols rearranged during the free game, and a single symbol is determined from among rearrangement symbols that are determined in accordance with the rearrangement pattern. For example, in a case where the symbol “3Bar” has been rearranged in the symbol matrix element SM during the free game, a “rearrangement pattern B” is determined in order to rearrange in the symbol matrix element SM a symbol allowed to award a higher payout than that of the previously-rearranged symbol “3Bar”. Thus, the single symbol to be rearranged is determined, the determined symbol is output from among the symbols “3Bar”, “7”, and “WILD” that are determined in accordance with the rearrangement pattern B, and then, the output symbol is rearranged.

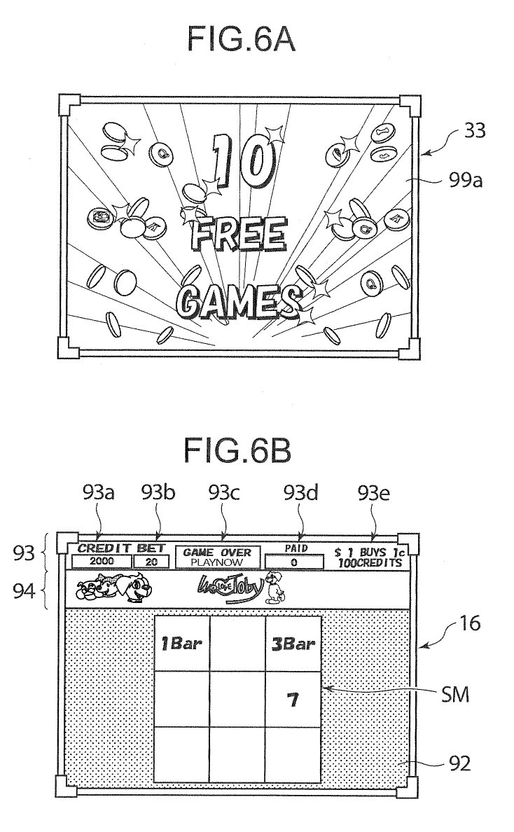

FIGS. 6A to 9B are views each showing an exemplary image displayed on the slot machine shown in FIG. 2 according to the first embodiment. FIGS. 6A and 6B each show an exemplary image displayed in the slot machine shown in FIG. 2 during the free game. As shown in FIG. 6A, when the free game is started, the upper image display panel 33 displays a free-game-number display image 90a indicative of the number of times in executing the free game. In this case, the free-game-number display image 90a of “10 FREE GAME” is displayed indicating that the number of times in executing the free game has been determined to be ten.

As shown in FIG. 6B, the lower image display panel 16 is made up of display-related sections such as a display region section 92, an information display section 93, and an effect image display section 94. In the display region section 92, the symbol matrix elements SM are displayed. The information display section 93 is arranged at an upper side of the display region section 92 and is made up of a credit amount display section 93a, a BET amount display section 93b, a character information display section 93c, a PAID amount display section 93d, and a charge display section 93e.

The number of coins presently credited is displayed at the credit amount display section 93a while the number of coins bet in one game is displayed at the BET amount display section 93b. The character information indicative of a current status of the game is displayed at the character information display section 93. The characters of “PLAYNOW” are displayed during the play of the game, whereas the characters of “GAMEOVER” are displayed at the intervals between the plays of the game. The number of coins that have been successfully obtained in one game is displayed at the PAID amount display section 93d, whereas a conversion value of the credit amount based on a predetermined charge is displayed at the charge display section.

On the effect image display section 94, effect images in accordance with a type of the current slot game are displayed. Therefore, the effect image display section 94 displays different effect images between the basic and free games.

A total of nine symbols in three columns and three rows are rearranged in the symbol matrix elements SM displayed on the lower image display panel 16. Any of the symbols, “Blank”, “1Bar”, “2Bar”, “3Bar”, “7”, and “WILD” are rearranged in the symbol matrix elements SM. In this case, the symbols “Blank”, “1Bar”, “3Bar”, and “7” are rearranged.

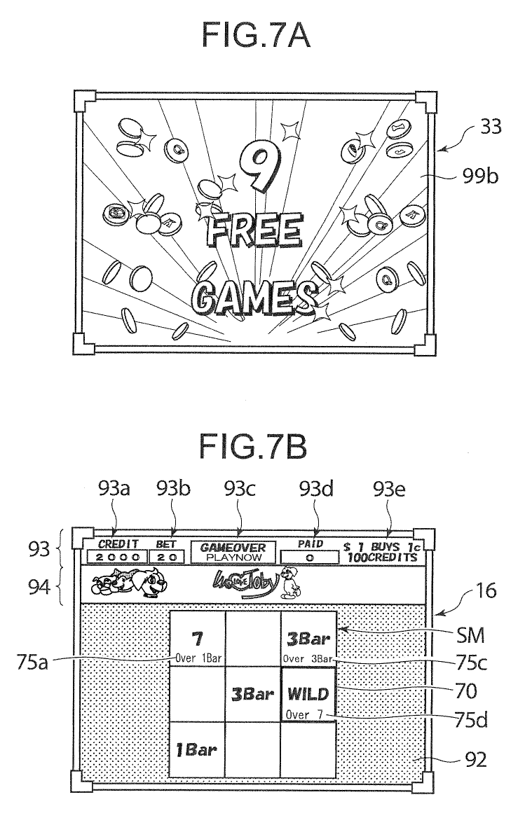

FIGS. 7A and 7B are views each showing an exemplary image displayed during the free game in the slot machine shown in FIG. 2. As shown in FIG. 7A, in a case where the free game is executed more than once, the upper image display panel 33 displays a free-game-number display image 90b indicative of the remaining number of times in executing the free game. In this case, the free-game-number display image 90b of “9FREE GAME” is displayed indicating that nine free games remain.

As shown in FIG. 7B, the display region section 92 displays the symbol matrix elements SM. Any of the symbols, “Blank”, “1Bar”, “2Bar”, “3Bar”, “7”, and “WILD” are rearranged in any of the individual symbol matrix elements SM during the free game. Further, where any of the symbols, “1Bar”, “2Bar”, “3Bar”, “7”, and “WILD” are rearranged, the level-up display 75 is displayed in a superimposed manner. In this case, the symbols, “1Bar”, “3Bar”, and “7” have been rearranged as shown in FIG. 6B, so that the symbols, “1Bar”, “3Bar”, “7”, and the “WILD” allowed to award higher payouts than those of the symbols having been rearranged during the previous free game are rearranged in the symbol matrix elements SM as shown in FIG. 7B. In the symbol matrix element SM in which the symbol “1Bar” has been rearranged as shown in FIG. 6B, the level-up display 75a “Over 1Bar” is displayed in a superimposed manner as shown in FIG. 7B, and the symbol “7” allowed to award a higher payout than that of the previously-rearranged symbol “1Bar” is rearranged.

In the symbol matrix element SM in which the symbol “3Bar” has been rearranged as shown in FIG. 6B, the level-up display 75b “Over 3Bar” is displayed in a superimposed manner as shown in FIG. 7B, and the symbol “3Bar” allowed to award a higher payout than that of the previously-rearranged symbol “3Bar” is rearranged. Further, in the symbol matrix element SM in which the symbol “7” has been rearranged as shown in FIG. 6B, the level-up display 75d “Over 7” is displayed in a superimposed manner, as shown in FIG. 7B; and the symbol “WILD” allowed to award a higher payout than that of the previously-rearranged symbol “WILD” is rearranged; and the frame 70 is displayed so as to identify the rearrangement of the symbol “WILD”.

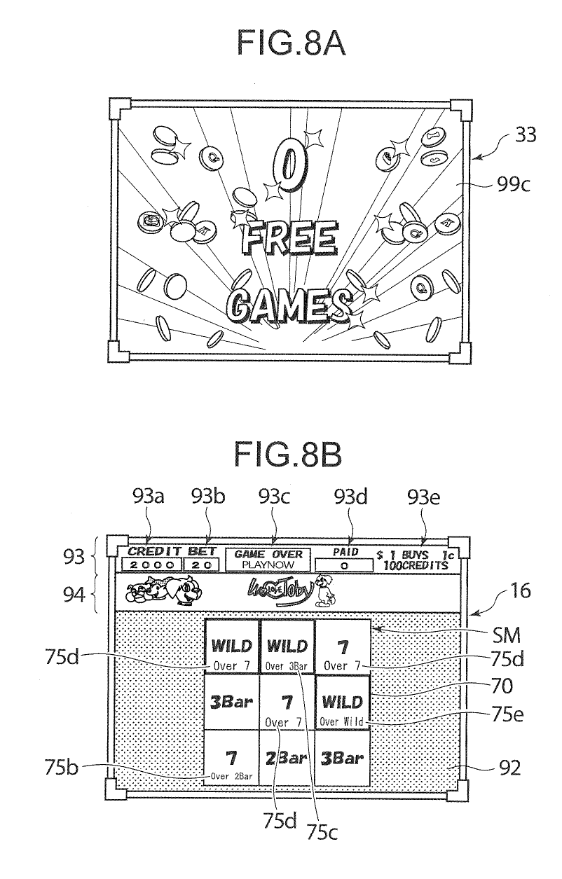

FIGS. 8A and 8B are views each showing an exemplary image displayed during the last free game in the slot machine shown in FIG. 2. As shown in FIG. 8A, upon execution of the last free game, the upper image display panel 33 displays a last-free-game display image 90c indicative of the last free game. In FIG. 8A, the last-free-game display image 90c of “0FREE GAME” is displayed which indicates that this is a last free game.

As shown in FIG. 8B, the display region 92 displays the symbol matrix elements SM. In a case where any of the symbols, “Blank”, “1Bar”, “2Bar”, “3Bar”, “7”, and “WILD” are rearranged in any of the individual symbol matrix elements SM during the free game, and any of the symbols, “1Bar”, “2Bar”, “3Bar”, “7”, and “WILD” are rearranged in any of the individual symbol matrix elements SM during the previous free games by the time of the last free game, the level-up display 75 is displayed in a superimposed manner. In this case, in the symbol matrix element SM in which the symbol “2Bar” has been rearranged during the previous free game, the level-up display 75b “Over 2Bar” is displayed in a superimposed manner and the symbol “7” allowed to award a higher payout than that of the previously-rearranged symbol “2Bar” is rearranged. In the symbol matrix element SM in which the symbol “3Bar” has been rearranged, the level-up display 75c “Over 3Bar” is displayed in a superimposed manner and the symbol “WILD” allowed to award a higher payout than that of the previously-rearranged symbol “3Bar” is rearranged. In the symbol matrix element SM in which the symbol “7” has been rearranged, the level-up display 75d “Over 7” is displayed in a superimposed manner and the symbol “7” or “WILD” allowed to award a higher payout than that of the previously-rearranged symbol “7” is rearranged.

In a case where the symbol “WILD” is rearranged, the frame 70 is displayed so as to identify that the symbol “WILD” has been rearranged. A payout is then determined based on a combination of the symbols established on a winning line and the number of symbols rearranged in the symbol matrix elements SM.

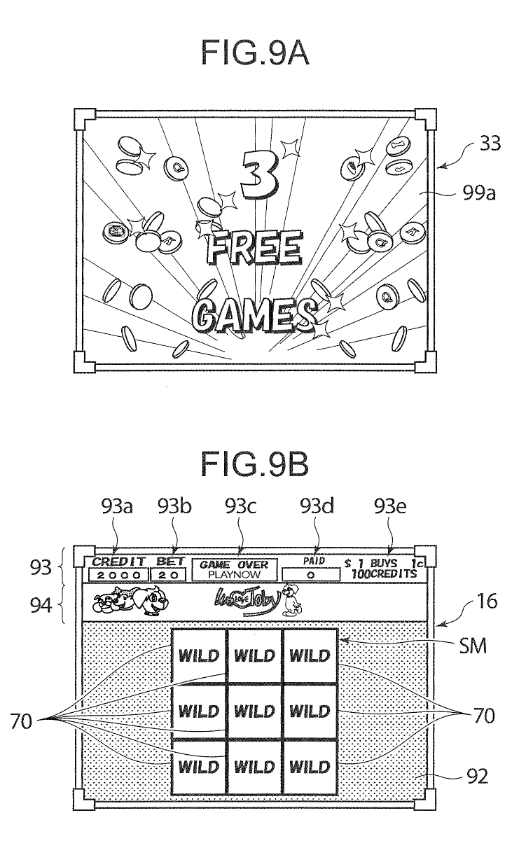

FIGS. 9A and 9B are views each showing an exemplary image displayed during the free game in the slot machine shown in FIG. 2. As shown in FIG. 9A, when the free game is executed more than once, the upper image display panel 33 displays the free-game-number display image 90b indicative of the remaining number of times in executing the free game. In this case, the free-game-number display image 90b of “3FREE GAME” is displayed indicating that three free games still remain.

As shown in FIG. 9B, in a case where any of the symbols “Blank”, “1Bar”, “2Bar”, “3Bar”, “7”, and “WILD” are rearranged in the any of the individual symbol matrix elements SM, and the symbol “WILD” is then rearranged in any one of the symbol matrix elements SM during the free game, the display region 92 displays the frame 70 so as to identify the rearrangement of the symbol “WILD”. In this case, the symbols “WILD” are rearranged in all of the symbol matrix elements, thereby terminating the free game and determining a payout corresponding to a winning combination of the symbols “WILD” (see FIG. 4A).

Next, a process executed in the slot machine 10 according to the first embodiment, will be described in detail with reference to the drawings. The main CPU 41 processes the game by reading out the game program.

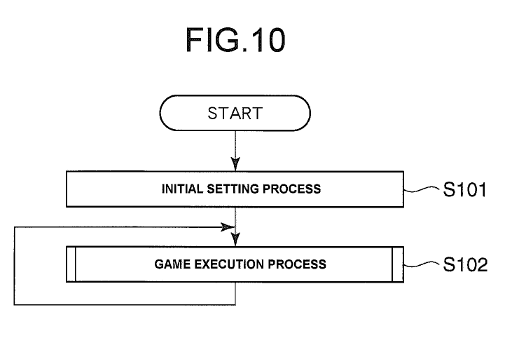

FIG. 10 is a flowchart showing a subroutine of a main process. In the main process, first, when a power switch is turned on (that is, when power is supplied), a mother board 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. The main CPU 41 writes game programs or the like from the ROM 42 into the RAM 43, and retrieves data for setting a payout ratio and country-identification information. The main CPU 41 also performs an authentication process for each program during execution of the initial setting process.

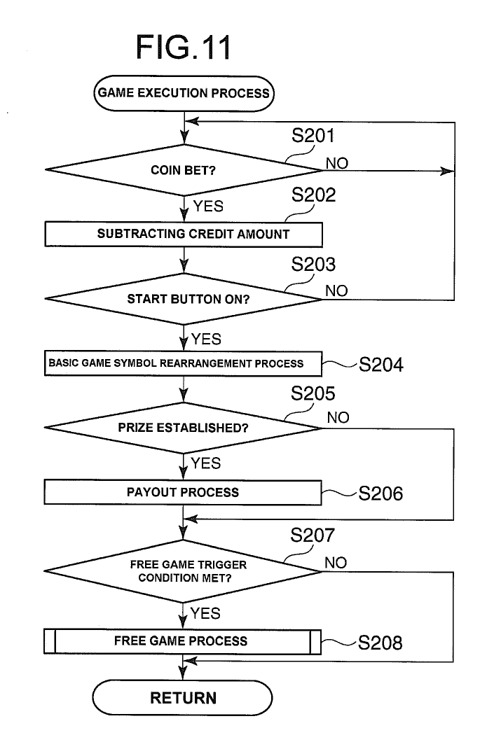

Next, the main CPU 41 performs a game execution process described later with reference to FIG. 11 (step S102). In this game execution process, the main CPU 41 performs the game execution process by sequentially reading and executing the game programs or the like from the ROM 42. By performing this game execution process, the slot machine 10 executes the game according to the first embodiment. The game execution process is repeatedly performed while power is supplied to the slot machine 10.

FIG. 11 is a flowchart showing a subroutine of the game execution process invoked and performed at step S102 of the subroutine shown in FIG. 10. First, the main CPU 41 judges whether or not a coin has been bet (step S201). Specifically, the main CPU 41 judges whether or not an input signal has been received, the input signal being output from the 1-BET switch 26S at the time of operation of the 1-BET button 26 or from the max-BET switch 27S at the time of operation of the max-BET switch 27. The main CPU 41 controls the current step to return to the process at the step S201 upon judging that no coin has been bet (step S201: NO).

On the other hand, the main CPU 41 subtracts the number of bet coins from the credit amount stored in the RAM 43 (step S202) upon judging that a coin has been bet (step S201: YES). Where the number of bet coins is larger than the credit amount stored in the RAM 43, the main CPU 41 controls the current step to return to step S101 without performing the process for subtracting the number of bet coins from the credit number stored in the RAM 43. Where the number of bet coins exceeds the upper limit (50 coins in this embodiment) of coins that can be bet in one game, the main CPU 41 controls the step to return to step 203 without performing the process for subtracting the number of bet coins from the credit number stored in the RAM 43.

Next, the main CPU 41 judges whether or not the start button 23 has been set to ON (step S203). Specifically, the main CPU 41 judges whether or not an input signal output from the start switch 23S at the time of pushing of the start button 23 has been received. The main CPU 41 controls the step to return to step 201 upon judging that the start button 23 has not been set to ON (step S203: NO). Where the start button 23 has not been set to ON (for example, where an instruction has been entered to terminate the game without setting the start button 23 to ON), the main CPU 41 cancels acceptance of a subtraction result at step S202.

On the other hand, the main CPU 41 performs a symbol rearrangement process of the basic game (step S204) upon judging that the start button 23 has been set to ON (step S203: YES). Specifically, the CPU 41 executes a program stored in the RAM 43 and determines the symbols to be rearranged in symbol matrix elements SM displayed on the lower image display panel, from among the symbols “Blank”, “1Bar”, “2Bar”, “3Bar”, “7”, and “WILD”. This determination is based on the symbol weighting data and random numeric values sampled by sampling the random numeric values in a numerical range which comes under a predetermined range of random numeric values. The CPU 41 then rearranges the symbols in symbol matrix elements SM.

Next, the main CPU 41 judges whether or not a prize has been established (step S205). Specifically, the main CPU 41 judges whether or not a combination of symbols having been rearranged in the symbol matrix elements SM is a winning combination allowed to award any of payouts. Herein, the prize is established on condition that a predetermined number of identical symbols are rearranged in the symbol matrix elements SM where predetermined symbols are rearranged (see FIG. 4).

Upon judging that the prize is established (step S205: YES), the main CPU 41 then performs a coin-payout process in accordance with the bet amount and the number of coins set for the winning combination (step S206). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

Meanwhile, the main CPU 41 judges whether a free game trigger condition has been met or not (step S207) when judging that the prize is not established (step S205: NO) or executing the process at step S206. Specifically, the main CPU 41 executes the program stored in the RAM 43 to sample the random numeric values in a numerical range which comes under a predetermined range of random numeric values, thereby judging whether or not the free game trigger condition has been met based on the sampled random numeric values. Upon judging that the free game trigger condition is met (step S207: YES), the main CPU 41 performs a free-game execution process described later with reference to FIG. 11 (step S208). In this free-game execution process, the main CPU 41 sequentially reads and executes the game programs or the like from the ROM 42 and performs the free-games execution process.

The CPU 41 terminates the game execution process when judging that the free game trigger condition is not met (step S207: NO) or when executing the process at step S208.

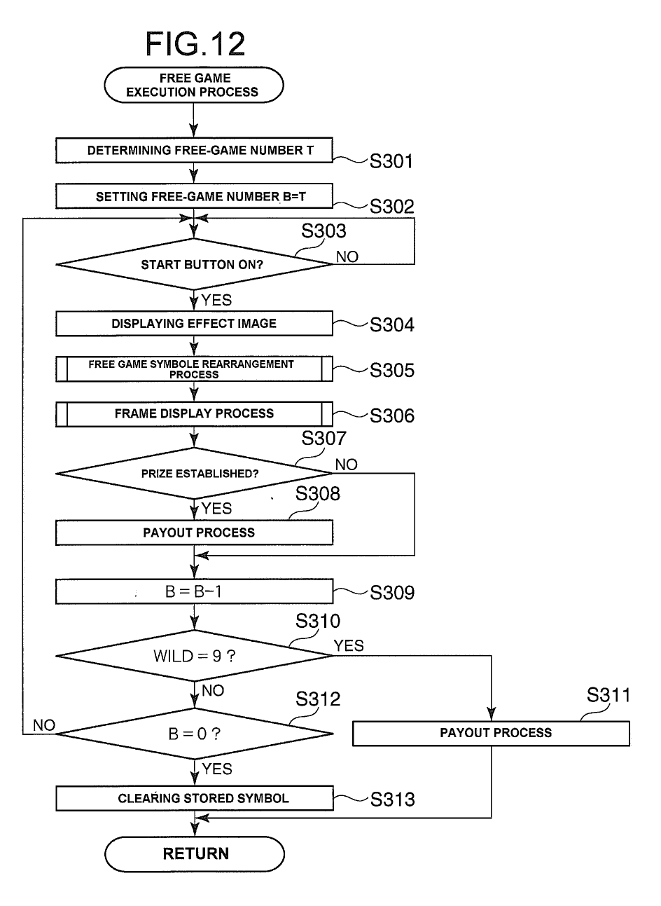

FIG. 12 is a flowchart showing a subroutine of a free-game execution process that is invoked and executed at step S208 of the subroutine shown in FIG. 11. First, the main CPU 41 determines a free-game number T as a number of times of the free game (step S301). Specifically, the main CPU 41 executes the program stored in the RAM 43, thereby reading the number of times in executing the free game that is set in association with a random number using a random numeric value sampled in a numerical range which comes under a predetermined range of random numeric values 1 to 256. After that, the main CPU 41 determines the free-game number T.

Next, the main CPU 41 sets a free-game number B=T (step S302) Specifically, the main CPU 41 sets a remaining free-game number B=T in a storage area of the data indicative of the remaining free-game number B as the remaining number of times in executing the free game, provided in the RAM 43. T is the free-game number determined at step S301.

The main CPU 41 then judges whether the start button 23 has been set to ON or not (step S303). Specifically, the main CPU 41 judges whether or not an input signal has been received, the signal being output from the start switch 23S at the time of pushing of the start button 23. The main CPU 41 controls the step to return to step 303 upon judging that the start button 23 has not been set to ON (step S303: NO).

Upon judging that the start button 23 hasp been set to ON (step S303: YES), the main CPU 41 performs a process for displaying effect images (step S304). Specifically, the main CPU 41 displays the free-game-number display images 90a to 90c (see, FIGS. 6A to 9B) corresponding to the number of times in executing the free game on the upper image display panel 33.

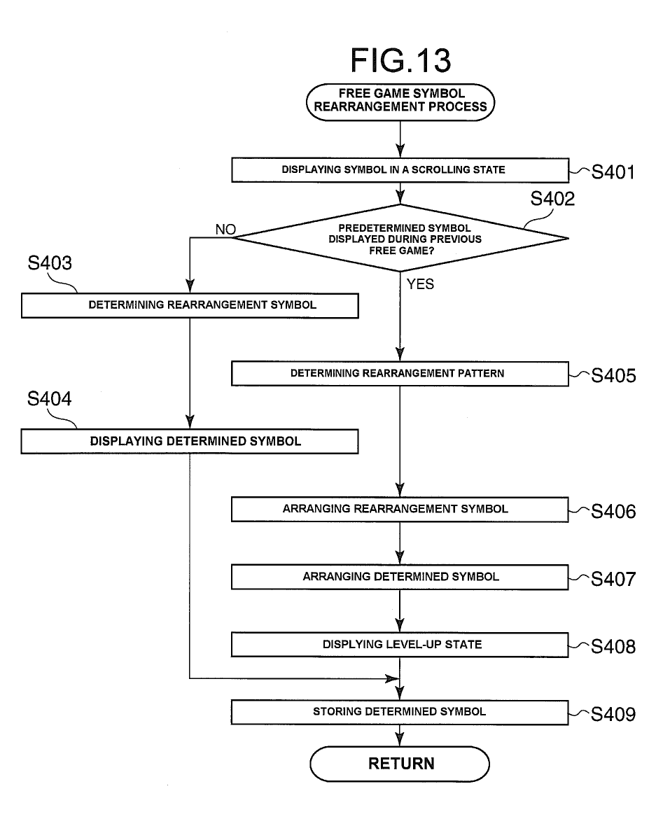

Next, the main CPU 41 performs a process for rearranging symbols during the free game, which is described later with reference to FIG. 13 (step S305). Specifically, the CPU 41 executes the program stored in the RAM 43 and determines the symbols to be rearranged in symbol matrix elements SM displayed in the lower image display panel 16, from among the symbols “Blank”, “1Bar”, “2Bar”, “3Bar”, “7”, and “WILD”. This determination is based on the symbol weighting data and random numeric values sampled by sampling the random numeric values in a numerical range which comes under a predetermined range of random numeric values. The CPU 41 then rearranges the symbols in symbol matrix elements SM.

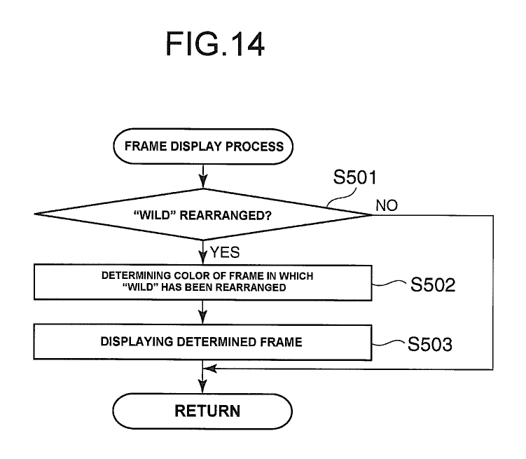

The main CPU 41 then performs a frame display process described later with reference to FIG. 14 (step S306). In this frame display process, the main CPU 41 performs a process for identifiably displaying a frame upon rearrangement of the symbol “WILD”.

Next, the main CPU 41 judges whether or not a prize has been established (step S307). Specifically, the main CPU 41 judges whether a combination of symbols having been rearranged in the symbol matrix elements SM is a winning combination that awards any of payouts. The prize is established on condition that a winning combination is realized in which a predetermined number of identical symbols are rearranged in the symbol matrix elements SM where predetermined symbols are rearranged (see, FIG. 4).

Thereafter, upon judging that the prize has not been established (step S307: YES), the main CPU 41 performs a coin-payout process in accordance with the bet amount and the number of coins set for the winning combination (step S307:YES). In the case where the coins are deposited, the main CPU 41 performs a process for adding the number of paid-out coins to the credit amount stored in the RAM 43. On the other hand, where the coins are paid out, the main CPU 41 pays out the predetermined number of coins by transmitting the control signal to the hopper 66.

On the other hand, upon judging that the prize has not been established (step S307: NO), or executing the process at step S308, the main CPU 41 sets the remaining free-game number B=B−1 (step S309). Specifically, the main CPU 41 sets B=B−1 at a value of the free-game number B stored in the RAM 43.

The main CPU 41 then judges whether or not the number of symbols “WILD” is equal to nine (step S310). Specifically, the main CPU 41 judges whether or not the symbols “WILD” have been rearranged in all of the symbol matrix elements SM (see, FIG. 9B). Upon judging that the symbols “WILD” have been rearranged in all of the symbol matrix elements SM (step S310: YES), the main CPU 41 performs the coin-payout process in accordance with the bet amount and the number of coins set for the winning combination (step S311). In a case where the coins are deposited, the main CPU 41 performs a process for adding the number of paid-out coin to the credit amount stored in the RAM 43. On the other hand, where the coins are paid out, the main CPU 41 pays out the predetermined number of coins by transmitting the control signal to the hopper 66. The main CPU 41 terminates the free game execution process when executing the process at step S313.

Upon judging that the number of symbols “WILD” is not equal to nine (step S310: NO), the main CPU 41 judges whether or not a value of the remaining free-game number B is equal to zero (step S312). Specifically, the main CPU 41 judges whether or not a value of the remaining free-game number B stored in the RAM 43 is equal to zero (step S312). Upon judging that the value of the remaining free-game number B is not equal to zero (step S312: NO), the main CPU 41 controls the step to return to step S303. On the other hand, upon judging that the value of B is equal to zero (step S312: YES), the main CPU 41 clears the stored symbols (step S313). Specifically, at step S409 in FIG. 13 described later, the main CPU 41 clears the symbols having been rearranged in the individual symbol matrix elements SM and stored once each free game. The main CPU 41 terminates the free game execution process when executing the process at step S313.

FIG. 13 is a flowchart showing a subroutine of a free game symbol rearrangement process invoked and executed at step S305 of the subroutine shown in FIG. 12. The main CPU 41 stores, in the RAM (memory) 43, identification data once each free game, the data concerning each of the symbols that are determined to be rearranged in the symbol display regions of the symbol matrix, respectively, during the free game. First, the main CPU 41 starts displaying the symbols in a scrolling manner, the symbols being rearranged in the symbol matrix elements SM in the lower image display panel 16 (step S401). At this time, in the symbol matrix elements SM, the six basic lines BL are set in a column or row direction while the two cross lines CL are set obliquely across the symbol matrix elements SM.

Next, the main CPU 41 judges whether or not the predetermined symbol has been displayed during the previous free game (step S402). Specifically, the main CPU 41 judges whether or not any of the symbols, “1Bar”, “2Bar”, “3Bar”, “7”, and “WILD” have been rearranged in any of the individual symbol matrix elements SM during the previous free game. Upon judging that the predetermined symbol has not been displayed during the previous free game (step S402: NO), the main CPU 41 determines the symbol to be rearranged (step S403). Specifically, the CPU 41 executes a program stored in the RAM 43 and determines the symbols to be rearranged in symbol matrix elements SM displayed on the lower image display panel 16, from among the symbols “Blank”, “1Bar”, “2Bar”, “3Bar”, “7”, and “WILD”. This determination is based on the symbol weighting data and random numeric values sampled by sampling the random numeric values in a numerical range which comes under a predetermined range of random numeric values.

The main CPU 41 then displays the determined symbol (step S404). Specifically, the main CPU 41 displays in the symbol matrix elements SM, the symbols that are determined to be rearranged the symbol matrix elements SM, respectively (see, FIG. 6B). The main CPU 41 controls the step to move to step S409 when terminating this process.

On the other hand, upon judging that the predetermined symbol has been rearranged during the previous free game (step D402: YES), the main CPU 41 determines a rearrangement pattern (step S405). Specifically, the main CPU 41 determines a rearrangement pattern of the symbols during the free game, from among symbol patterns stored in the ROM 43 so that the symbols are allowed to award higher payouts than those of the symbols which have been rearranged in the symbol matrix elements SM during the previous free game. For example, in a case where the symbol “2Bar” has been rearranged in the symbol matrix element SM during the previous free game, the “rearrangement pattern B” is determined in order to rearrange in the symbol matrix element SM the symbol allowed to award a higher payout than that of the symbol “2Bar” (see, FIG. 5).

Next, the main CPU 41 determines the symbol to be rearranged (step S406). Specifically, the main CPU 41 determines the single symbol from among the symbols in the rearrangement pattern determined at step S405. Further, first identification data is relevant to the symbol determined to be rearranged while second identification data is relevant to the symbol having been stored in the RAM 43 memory and rearranged in the symbol matrix element SM during the previous free game. Herein, in a case where a predetermined relationship is established between the first and second identification data, the main CPU 41 determines the plural types of symbols to be rearranged in the symbol matrix elements SM, respectively, without rearranging the symbols corresponding to the first identification data having been determined to be rearranged while maintaining a rearrangement status of the symbols corresponding to the second identification data. In this embodiment, in a case where the symbol corresponding to the second identification data is allowed to award a higher payout than that of the symbol corresponding to the first identification data, the main CPU 41 judges that the predetermined relationship has been established. Next, the main CPU 41 rearranges the symbols determined at step S406 (step S407). Specifically, the main CPU 41 rearranges the determined symbols in the individual symbol matrix elements SM.

The main CPU 41 then displays a level-up state (step S408). Specifically, the main CPU 41 displays the level-up display 75 corresponding to the symbol having been rearranged in the symbol matrix element SM during the previous free game. For example, in the symbol matrix element SM in which the symbol “7” has been rearranged during the previous free game, the level-up display 75d “Over 7” is to be displayed in a superimposed manner (see FIGS. 7B and 8B).

Next, the main CPU 41 stores the determined symbol (step S409). Specifically, the main CPU 41 stores in the ROM 42 the symbols rearranged in the individual symbol matrix elements SM at the step S404 or S407. The main CPU 41 terminates the free game symbol rearrangement process when executing the process at step S409.

FIG. 14 is a flowchart showing a subroutine of a frame display execution process invoked and executed at step S306 of the subroutine shown in FIG. 12. First, the main CPU 41 judges whether or not the symbol “WILD” has been rearranged during the free game (step S501). Specifically, the main CPU 41 judges whether or not the symbol “WILD” has been rearranged in any of the symbol matrix elements SM during the free game. Upon judging that the symbol “WILD” has not been rearranged during the free game (step S501: NO), the main CPU 41 terminates the frame display process.

On the other hand, upon judging that the symbol “WILD” has been rearranged during the free game (step S501: YES), the main CPU 41 determines a color of a frame in which the symbol “WILD” has been rearranged (step S502). Specifically, the main CPU 41 determines a color of a frame correspondingly to a gaming mode.

The main CPU 41 displays the determined frame (step S503). Specifically, the main CPU displays a frame 70 so as to identifiably display the rearranged symbol “WILD” (see FIGS. 7B, 8B, and 9B). The main CPU 41 terminates the frame display process when executing the process at step S503.

Next, a slot machine 100 according to a second embodiment will be described with reference to the drawings. The slot machine according to the second embodiment below is a so-called hybrid slot machine in which a plurality of rotatably-supported mechanical reels have a transparent liquid crystal panel on front surfaces to display images of various symbols drawn on peripheral surfaces of the mechanism reels through the transparent liquid crystal panel through which the pictures are allowed to pass. The slot machine according to the second embodiment has an appearance, circuitry, and the like that are substantially the same as those of the slot machine 10 according to the first embodiment. Thus, a duplicated explanation is omitted here. Constituent elements corresponding to those of the slot machine 10 are designated by the same reference numerals and are explained.

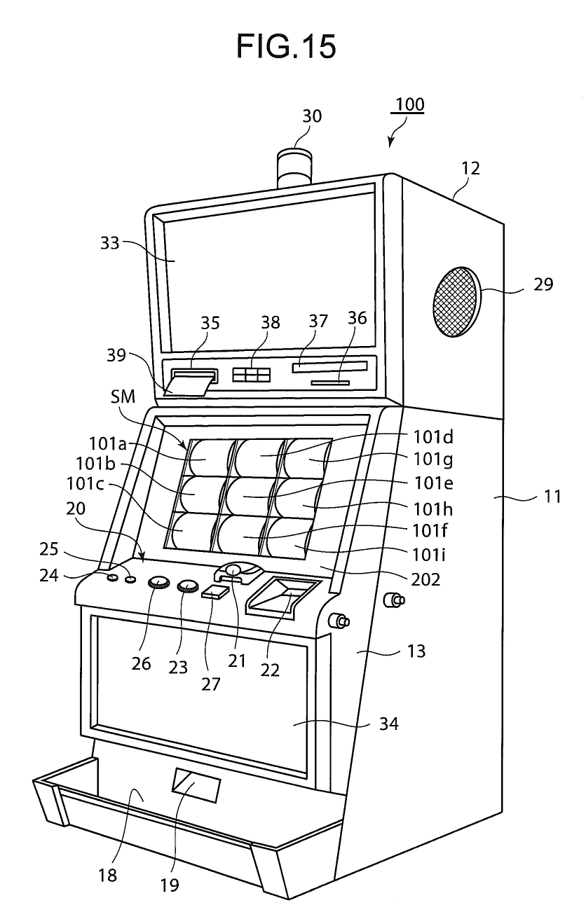

FIG. 15 is a view for schematically showing the appearance of the slot machine according to the second embodiment of the present invention. As shown in FIG. 15, the slot machine 100 is rotatably provided with nine reels 101a to 101i. On the respective one of the outer circumferential surfaces of the reels 101a to 101i, a symbol column made up of the symbols “Blank”, “1Bar”, “2Bar”, “3Bar”, “7”, and “WILD” is drawn.

A main liquid crystal 202 formed of a transparent liquid crystal panel, which is disposed at the main door, is provided in front of the respective reels 101a to 101i. The main liquid crystal panel 202 displays symbol matrix elements SM with visually recognizable rear surfaces so as to surround symbols displayed in the reels 101a to 101i in a stopped state, respectively. The symbols drawn on the reels 101a to 101i are visualized by rendering the symbol matrix elements SM transparent.

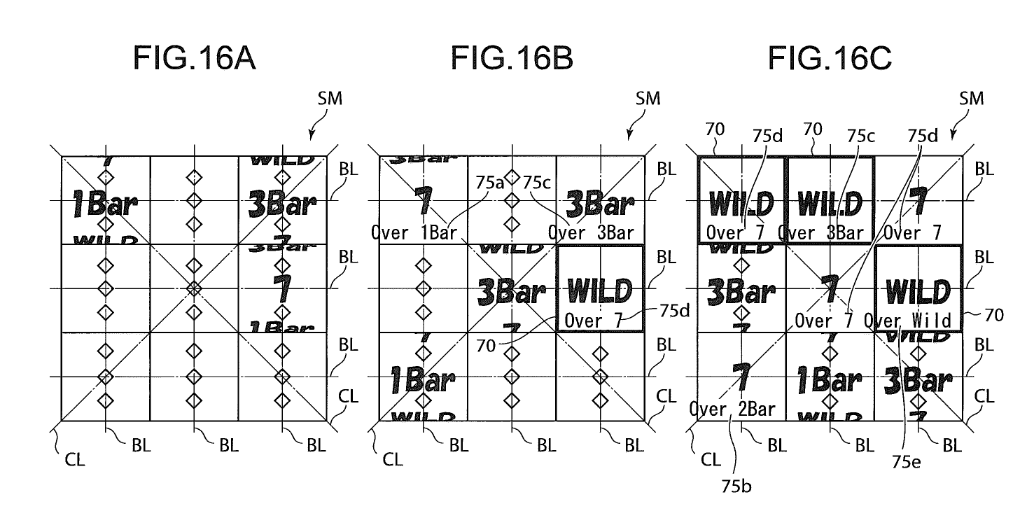

FIGS. 16A and 16B are views each showing exemplary symbol matrix elements during the free game. FIG. 16C is a view showing exemplary symbol matrix elements at the time of termination of the free game. It should be noted that FIG. 16A shows the exemplary symbol matrix during the first free game; FIG. 16B shows the exemplary symbol matrix during the second free game; and FIG. 16C shows the exemplary symbol matrix during the last free game. As shown in FIGS. 1A to 16C, the symbol matrix elements SM are displayed on the liquid crystal panel 202 provided at the slot machine 100 according to the present invention. A back side of the liquid crystal panel 202 is provided with a total of nine reels 101a to 101i in three columns and three rows in a rotatable manner.

As shown in FIGS. 1A and 16A, any of the symbols, “Blank”, “1Bar”, “2Bar”, “3Bar”, “7”, and “WILD” drawn on the nine reels 101a to 101i are displayed in a stopped state during the free game. In this case, the symbols, “Blank”, “1Bar”, “3Bar”, and “7” are displayed in a stopped state.

As shown in FIG. 16B, where any of the symbols “Blank”, “1Bar”, “2Bar”, “3Bar”, “7”, and “WILD” have been displayed in a stopped state on any of the nine reels 101a to 101i during the previous free game, the level-up display 75 is displayed on the liquid crystal panel 202. Because the symbols “1Bar”, “3Bar”, and “7” have been displayed in a stopped state in FIG. 16A, the reels 101 on which these symbols have been displayed in a stopped state display thereon in a stopped state the symbols “1Bar”, “3Bar”, “7”, and “WILD” allowed to award higher payouts than those of the above symbols having been displayed in a stopped manner. In the symbol matrix element SM in which the symbol “1Bar” has been displayed in a stopped state in FIG. 16A, the level-up display 75a “Over 1Bar” is displayed on the liquid crystal panel 202 and the symbol “7” allowed to award a higher payout than that of the previously-displayed symbol “1Bar”.

Further, in the symbol matrix element SM in which the symbol “3Bar” has been displayed in a stopped state in FIG. 16A, the level-up display 75b “Over 3Bar” is displayed on the liquid crystal panel 202 and the symbol “3Bar” allowed to award a higher payout than that of the previously-displayed symbol “3Bar” is displayed in a stopped state. Yet further, in the symbol matrix element SM in which the symbol “7” has been displayed in a stopped state in FIG. 16A, the level-up display 75d “Over 7” is displayed in the liquid crystal panel 202; the symbol “WILD” allowed to award a higher payout than that of the previously-displayed symbol “7” is displayed in a stopped state; and the frame 70 is displayed in the liquid crystal panel 202 so as to identify the display of the symbol “WILD” in a stopped state.

As shown in FIG. 16C, in a case where any of the symbols, “1Bar”, “2Bar”, “3Bar”, “7”, and “WILD” have been displayed in a stopped state in any of the respective reels 101a to 101i during the previous free games by the time of the last free game, the level-up display 75 is displayed on the liquid crystal panel 202. In FIG. 1C, in the symbol matrix element SM in which the symbol “2Bar” has been displayed in a stopped state during the previous free game, the level-up display 75b “Over 2Bar” is displayed on the liquid crystal panel 202 and the symbol “7” allowed to award a higher payout than that of the previously-displayed symbol “2Bar” is displayed in a stopped state. In the symbol matrix element SM in which the symbol “3Bar” has been displayed in a stopped state during the previous free game, a level-up display 75c “Over 3Bar” is displayed on the liquid crystal panel 202 and the symbol “WILD” allowed to award a higher payout than that of the previously-displayed symbol “3Bar” is displayed in a stopped state. In the symbol matrix element SM in which the symbol “7” has been displayed in a stopped state during the previous free game, the level-up display 75d “Over 7” is displayed on the liquid crystal panel 202 and the symbol “7” or “WILD” allowed to award a higher payout than that of the previously-displayed symbol “7” is displayed in a stopped state.

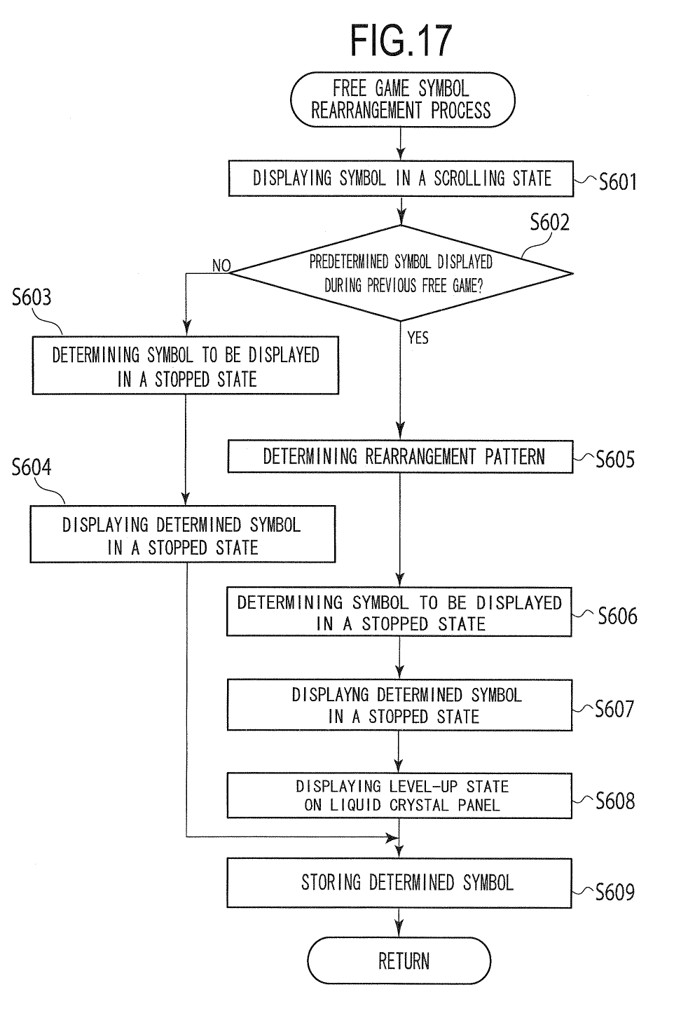

FIG. 17 is a flowchart showing a subroutine of a free game symbol rearrangement process invoked and executed at step S305 of the subroutine shown in FIG. 12. First, the main CPU 41 starts displaying the symbols in a scrolling manner, the symbols being rearranged in the symbol matrix elements SM in the lower image display panel 16 (step S601). In the symbol matrix elements SM, at this time, the six basic lines BL are set in a column or row direction while the two cross lines CL are set obliquely across the symbol matrix elements SM.

Next, the main CPU 41 judges whether or not the predetermined symbol has been displayed during the previous free game (step S602). Specifically, the main CPU 41 judges whether or not any of the symbols, “1Bar”, “2Bar”, “3Bar”, “7”, and “WILD” have been displayed in a stopped state in any of the respective reels 101a to 101i during the previous free game. Upon judging that the predetermined symbol has not been displayed in a stopped state during the previous free game (step S602: NO), the main CPU 41 determines the symbol to be displayed in a stopped state (step S603). Specifically, the CPU 41 executes a program stored in the RAM 43 and determines the symbols to be displayed in a stopped state on the reels 101a to 101i, SM, from among the symbols “Blank”, “1Bar”, “2Bar”, “3Bar”, “7”, and “WILD”. This determination is based on the symbol weighting data and random numeric values sampled by sampling the random numeric values in a numerical range which comes under a predetermined range of random numeric values.

The main CPU 41 then displays the determined symbol in a stopped state (step S604). Specifically, the main CPU 41 displays the symbols in a stopped state, the symbols being determined to be displayed on the reels 101a to 101i, respectively (see, FIG. 16). The main CPU 41 controls the step to move to step S609 when terminating this process.

On the other hand, upon judging that the predetermined symbol has been displayed in a stopped state during the previous free game (step D602: YES), the main CPU 41 determines a rearrangement pattern (step S605). Specifically, the main CPU 41 determines a rearrangement pattern of the symbols during the free game, from among symbol patterns stored in the ROM 43 so that the symbols are allowed to award higher payouts than those of the symbols which have been displayed in a stopped state in the symbol matrix elements during the previous free game. For example, in a case where the symbol “2Bar” has been displayed in a stopped state in the symbol matrix element SM during the previous free game, the “rearrangement pattern B” is determined in order to display in the symbol matrix element SM the symbol allowed to award a higher payout than that of the previously-displayed symbol “2Bar”.

Next, the main CPU 41 determines the symbol to be displayed in a stopped state (step S606). Specifically, the main CPU 41 determines the single symbol from among the symbols in the rearrangement pattern determined at step S605. Next, the main CPU 41 displays in a stopped state the symbols having been determined at step S606 (step S607). Specifically, the main CPU 41 displays in a stopped state the symbols having been determined to be displayed on the reels 101a to 101i, respectively.

The main CPU 41 then displays a level-up state (step S608). Specifically, the main CPU 41 displays on the liquid crystal panel 202 the level-up display 75 corresponding to the symbol having been displayed in a stopped state in the symbol matrix element SM during the previous free game. For example, in the symbol matrix element SM in which the symbol “7” has been displayed in a stopped state during the previous free game, the level-up display 75d “Over 7” is to be displayed on the liquid crystal panel 202 (see, FIG. 16).

Next, the main CPU 41 stores the determined symbol (step S609). Specifically, the main CPU 41 stores in the ROM 42 the symbols displayed in a stopped state on the respective reels 101a to 101i at the step S604 or S606. The main CPU 41 terminates the free game symbol rearrangement process when executing this process.

In the foregoing, while the embodiments of the present invention have been described, these embodiments merely present specific examples. An appropriate design change can be made for the specific configuration of each means or the like. Also, the effects described in the embodiments of the present invention are only listing the most preferable effects arising from the present invention, and the effects of the present invention are not limited to those described in the embodiments of the present invention.

What is claimed is:

1. A slot machine, comprising:
a display device having a plurality of symbol display regions in which plural types of symbols are displayed;
a memory for storing identification data of the symbols determined to be rearranged in the individual symbol display regions of a symbol matrix; and
a processor for controlling the display device and the memory, the processor being programmed to:
(a) execute a basic game;
(b) execute a free game in a case where a predetermined condition is met during the basic game;
(c) store once each free game in the memory, the identification data of the symbols determined to be rearranged in the individual symbol display regions of the symbol matrix during the free game; and
(d) rearrange the plural types of symbols in the individual symbol display regions while maintaining a rearrangement status of the symbols corresponding to second identification data without rearranging the symbols corresponding to first identification data determined to be rearranged, in a case where a predetermined relationship is established between the first identification data of the symbols determined to be rearranged during a next free game and the second identification data of the symbols, having been stored in the memory, the symbols being rearranged in the individual symbol display regions during a previous free game.

2. The slot machine according to claim 1, wherein the processor rearranges the plural types of symbols in the individual symbol display regions while maintaining the rearrangement status of the symbols corresponding to the second identification data without rearranging the symbols corresponding to the first identification data determined to be rearranged, in a case where the symbols corresponding to the second identification data are allowed to award a higher payout than that of the symbols corresponding to the first identification data in the itemized (d).

3. The slot machine according to claim 1 or claim 2, wherein:
the processor further programmed to:
(e) upon execution of the itemized (d), display in a superimposed manner the symbols corresponding to the first identification data determined to be rearranged but actually not rearranged, on the symbols corresponding to the second identification data rearranged in the individual symbol display regions.

4. A slot machine, comprising:
a display device having a plurality of symbol display regions in which plural types of symbols are displayed;
a memory for storing identification data of the symbols determined to be rearranged in the individual symbol display regions of a symbol matrix; and
a processor for controlling the display device and the memory, the processor being programmed to:
(a) execute a basic game;
(b) execute a free game in a case where a predetermined condition is met during the basic game;
(c) store once each free game in the memory, the identification data of the symbols determined to be rearranged in the individual symbol display regions of the symbol matrix during the free game; and
(d) rearrange the plural types of symbols in the individual symbol display regions while maintaining a rearrangement status of the symbols corresponding to second identification data without rearranging the symbols corresponding to first identification data determined to be rearranged, in a case where the symbols corresponding to the second identification data having been stored in the memory and rearranged in the individual symbol display regions during a previous free game is allowed to award a higher payout than that of the symbols corresponding to the first identification data, determined to be rearranged during a next free game.

5. The slot machine according to claim 4, wherein:
the processor further programmed to:
(e) upon execution of the itemized (d), display in a superimposed manner the symbols corresponding to the first identification data, determined to be rearranged but actually not rearranged, on the symbols corresponding to the second identification data rearranged in the individual symbol display regions.

6. A slot machine, comprising:
a display device having a plurality of symbol display regions in which plural types of symbols are displayed;
a memory for storing identification data of the symbols determined to be rearranged in the individual symbol display regions of a symbol matrix; and
a processor for controlling the display device and the memory, the processor being programmed to:
(a) execute a basic game;
(b) execute a free game in a case where a predetermined condition is met during the basic game;
(c) store once each free game in the memory, the identification data of the symbols determined to be rearranged in the individual symbol display regions of the symbol matrix during the free game;
(d) rearrange the plural types of symbols in the individual symbol display regions while maintaining a rearrangement status of the symbols corresponding to second identification data without rearranging the symbols corresponding to first identification data determined to be rearranged, in a case where the symbols corresponding to the second identification data having been stored in the memory and rearranged in the individual symbol display regions during a previous free game are allowed to award a higher payout than that of the symbols corresponding to the first identification data, determined to be rearranged during a next free game; and
(e) upon execution of the itemized (d), display in a superimposed manner the symbols corresponding to the first identification data, determined to be rearranged but actually not rearranged, on the symbols corresponding to the second identification data, the symbols being rearranged in the individual symbol display regions.
